(19) United States
(12) Patent Application Publication
(10) Pub. No.: US 2010/0250528 A1
(43) Pub. Date: Sep. 30, 2010

(54) QUICKLINK SELECTION FOR NAVIGATIONAL QUERY

(76) Inventors: Kunal Punera, Mountain View, CA (US); Deepayan Chakrabarti, Mountain View, CA (US); Shanmugasundaram Ravikumar, Santa Clara, CA (US)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 12/412,252

(22) Filed: Mar. 26, 2009

(51) Int. Cl. G06F 17/30

(52) U.S. Cl. 707/726; 707/E17.017; 707/E17.108

(57) ABSTRACT

According to techniques described herein, the best set of quicklinks is picked to maximize the benefits for a majority of the users of a search engine, since the “real estate” on a search results page is constrained and valuable. Quicklinks are navigational shortcuts that are displayed below the website homepage on a search results page. Using user browsing trails obtained from browser toolbars, and a simple probabilistic model, the quicklink selection program is formulated as a combinatorial optimization problem. Two techniques are proposed herein: a greedy technique and a tree-based technique. The tree-based technique finds an optimal solution, but may do so in a greater amount of time than the greedy technique takes to find a solution that is not guaranteed to be optimal. The tree-based technique may incorporate natural constraints on the set of chosen quicklinks.

### FIELD OF THE INVENTION

The present invention relates to techniques for automatically selecting which “quick links,” of a plurality of “quick links,” will be displayed in conjunction with a web site's search result listing on a search results web page returned by an Internet search engine.

### BACKGROUND

Internet search engines allow computer users to use their Internet browsers (e.g., Mozilla Firefox) to submit search query terms to those search engines by entering those query terms into a search field (also called a “search box”). After receiving query terms from a user, an Internet search engine determines a set of Internet-accessible resources that are pertinent to the query terms, and returns, to the user's browser, as a set of search results, a list of the resources most pertinent to the query terms, usually ranked by query term relevance.

These resources are often individual web pages or web sites. Web sites often contain multiple web pages, which share a same domain (e.g., “www.nasa.gov”) and usually contain user-selectable hyperlinks to each other. The list of resources typically contains, for each resource, at least a Uniform Resource Locator (URL) of that resource, a title of that resource, and a brief abstract for that resource. Often, for each web site indicated in the search results, the URL shown in the search results for that web site is a URL of a “front page” for that web site. A web site's “front page” is typically the web page to which the user's Internet browser would be directed if the user entered nothing more than the web site's domain name (with no following directories) in the Internet browser's URL navigation field.

More recently, search results have included, for each web site resource indicated in the search results, information that is additional to a URL, title, and abstract for that web site. For example, some Internet search engines additionally indicate, along with each web site indicated in the search results, a set of one or more hyperlinks to various web pages on the web site and/or specified locations within web pages on the web site. For example, a search result listing for the “NASA” web site might indicate (beneath the title, abstract, and web site URL (e.g., www.nasa.gov)), a set of user-selectable hyperlinks labeled “Missons,” “Shuttles & Station,” “Multimedia,” “Universe,” “News,” “Solar System,” “Aeronautics,” and “Technology.” Each of these links may point to a different web page, or specified location within a web page, that is a part of the NASA web site. By clicking on one of these links in an Internet browser, the user directs his Internet browser to a specific web page location within the web site rather than the web site's “front page.” The addition of these links to a search result listing often helps a user to bypass portions of a web site in which the user might not be interested, so that the user can jump directly to the portion of the web site in which the user is interested without forcing the user to successively follow a path of one or more links from the “front page” to the portion of the web site in which the user is interested. These links are called “quick links.” Quick links help a user to get to the information in which the user is interested more quickly.

Only so much information will fit on a single search results page returned from an Internet search engine in response to a user's query. If a variety of search result listings are to be presented on the search results page, then the quantity of information presented with each search result listing is naturally limited. Every inch of space on the search results page is valuable—especially given the willingness of some advertisers to pay for the privilege of having their advertisements or sponsored search results presented on the search results page. Although quick links to every possible aspect of interest within a web site theoretically could be presented in that web site's search result listing, practical considerations make this option infeasible. Therefore, prudence suggests that some subset of all of the quick links that could be presented in conjunction with a web site's search result listing ought to be shown in the search results web page; some quick links that could have been displayed will not be displayed. The challenge, then, comes in the problem of selecting which of a web site's many presentable quick links actually will be shown to a user along with the web site's listing in the search results page that the Internet search engine returns.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

Various embodiments of the present invention are illustrated by way of example, and not by way of limitation, in the figures of the accompanying drawings and in which like reference numerals refer to similar elements and in which:

FIG. 1 is a diagram that illustrates an example of a portion of a search results page that is returned by an Internet search engine and which includes multiple quicklinks displayed in conjunction with a particular search result, according to an embodiment of the invention;

FIG. 2 is a flow diagram that illustrates an example of a “greedy” technique for selecting a set of nodes whose corresponding quicklinks will be displayed in connection with a particular search result on a search results page returned by a search engine, according to one embodiment of the invention; and

FIG. 3 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### OVERVIEW

According to techniques described herein, the best set of quicklinks is picked automatically to maximize the benefits for a majority of the users of a search engine, since the “real estate” on a search results page is constrained and valuable. Quicklinks are navigational shortcuts that are displayed below the website homepage on a search results page. Using user browsing trails obtained from browser toolbars, and a probabilistic model, the quicklink selection program is formulated as a combinatorial optimization problem. Two techniques for solving this problem are discussed herein: a greedy technique and a tree-based technique. The tree-based technique finds an optimal solution, but may do so in a greater amount of time than the greedy technique takes to find a solution that is not guaranteed to be optimal. The tree-based technique incorporates natural constraints on the set of chosen quicklinks.

Ideally, given a “quicklink budget” of a maximum number of quicklinks that can be displayed in a particular search result listing, the quicklinks that are selected for display in the particular search listing should have several qualities. Quicklinks selected for display should point to the destinations, in the listing's website, to which most users apparently want to navigate, as evidenced by previous user navigation behavior relative to the website's several web pages. There is little sense in displaying a quicklink to a destination in which no one is apparently interested if the display of that quicklink will necessitate excluding the display of another quicklink to a destination in which many users have previously evidenced interest.

Additionally, quicklinks selected for display should be those that will save users the most time due to those users consequently not needing to navigate manually to those quicklinks' destinations from the website's “front page” or root URL. There is probably little sense in displaying a quicklink to a popular destination to which the website's root directly links, if the display of that quicklink will necessitate excluding the display of another quicklink whose destination, though perhaps slightly less popular, can only be reached from the root (or from another displayed quicklink's destination) through the manual performance of a highly time-consuming multi-page navigation.

Furthermore, on a related note, quicklinks selected for display should be minimally redundant in view of the other quicklinks that have also been selected for display in a particular search listing. Thus, if one of the quicklinks selected for display points directly to a particular destination, then there should be a bias against also selecting, for display, other quicklinks that point directly to other destinations that themselves are linked closely with the particular popular destination. This bias should exist because other quicklinks that point to destinations that are very closely linked with an already-selected quicklink's destination will probably not save the user much more time, in seeking his interest on the web site, than the already-selected quicklink does. Such other quicklinks are likely to be more redundant and less time-saving, in view of the already-selected quicklink, than are quicklinks that point to destinations that are less closely linked with the already-selected quicklink's destination.

Techniques discussed below generally seek to select, automatically, for each search result listing, a set of quicklinks that possess these qualities.

### Trails and Notation

According to one embodiment of the invention, quicklinks for a website are selected for display along with a search result for that website based at least in part on “trails” that occur within a directed graph that represents the links between the pages of the website. For purposes of explanation herein, an example website is labeled W. In website W, a set V is the set of web pages that are included within website W. Each web page of set V is a separate node in the directed graph. Each web page in set V is associated with a separate URL. In the discussion herein, u denotes both a web page and that web page's URL. One of the web pages in set V is the “root” or “home” or “front” page of the website-the web page to which a user's browser is usually directed if the user enters the website's URL (with no additional path information) into the browser's navigation field. Typically, this “root” page will contain links to other web pages in website W. For purposes of discussion herein, this “root” page is denoted as r. A set E is the set of directed edges in the directed graph. For each link from one webpage in V to another webpage in V, there is, in set E, a directed edge that represents that link. Together, the nodes in V and the edges in E represent the directed graph for website W.

Multiple “trails” occur within this directed graph. Each trail is a directed path within the graph—a trail begins at root node r and follows one or more edges in E through one or more other nodes in V until a destination node is reached. A trail p may be expressed formally as p=p₁, p₂ . . . pₙ, where p₁=r and pₙ is the last node in the trail. Each edge within the trail may be expressed as a pair of nodes from p, denoted (pᵢ, pᵢ₊₁). A trail may contain more than one instance of a particular node. Under such circumstances, the trail contains a loop wherein one or more nodes are repeated along the trail.

Users visiting a website traverse from page to page on that website by clicking on hyperlinks between the pages, thereby following some trail. A user spends some amount of time at each page before following a link to the next page on the trail. If a user follows a particular trail p, then the time that a user spends visiting page pi before leaving that page to navigate to page pᵢ₊₁ may be expressed as t(pᵢ, pᵢ₊₁ ). For a particular website W, all of the possible trails within website W may be denoted as P. For any trail p within P, the set of nodes along path p define a set Q|ₚ that contains all of the nodes along path p.

### Quicklink Selection Problem

The number of quicklinks that ought to be selected for presentation along with a particular website when that website appears as a search result may vary and can be specified by a search engine administrator or other user. In the discussion herein, the maximum number of quicklinks that are to be selected for presentation with a search result is called the “quicklink budget,” and is denoted as k. For example, the quicklink budget k might be 8, such that at most 8 quicklinks are selected and displayed along with a website when that website appears within search results on a search results page. Typically, a link to root page r will not be selected as one of the quicklinks, and does not count toward the quicklink budget, since the URL for root page r is typically the URL that is usually displayed for the website's search result anyway. The goal of the “quicklink selection problem” is to select k quicklinks that are the “best” that could be shown to a user who receives the search results. The “best” set of quicklinks typically will possess certain qualities, some of which are discussed above.

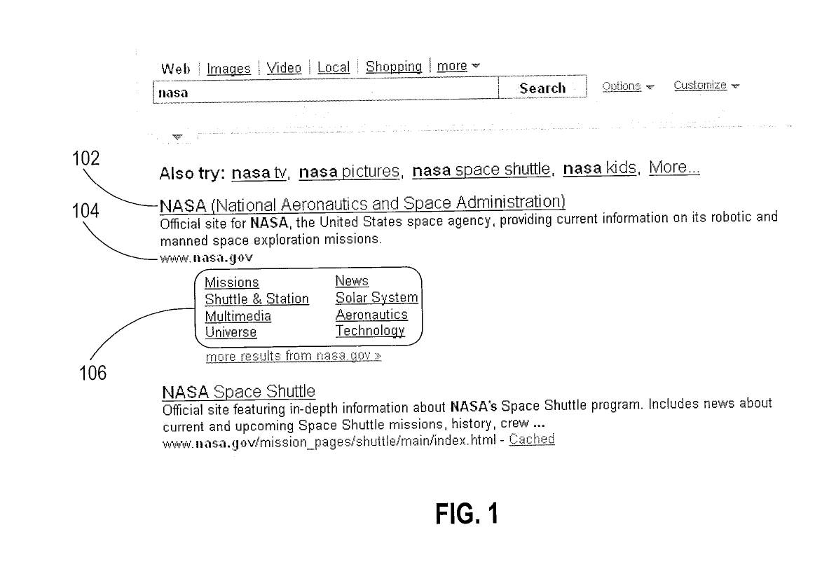

FIG. 1 is a diagram that illustrates an example of a portion of a search results page that is returned by an Internet search engine and which includes multiple quicklinks displayed in conjunction with a particular search result, according to an embodiment of the invention. The search results page includes a search result 102, with a root URL 104 (which refers to the URL “www.nasa.gov”—the “website” of this example), and, in this case, a set of eight different quicklinks 106. Each of the quicklinks, when selected, directs the browser to a different page within the website—a page other than the one located at the root URL and represented by the search result as a whole.

### Quicklink Noticeability and Benefit

For a given website, a user will have some information need that can be satisfied by one or more pages of the website. Some trail within the website will contain the one or more pages that will satisfy the user's information need. Sometimes, only the last page within that trail will satisfy the user's information need, and the user will navigate to the other pages in the trail merely because the links between those pages eventually leads to the page that ultimately satisfies the user's information need. A user might or might not be able to identify or notice that a particular page within the website will be likely to belong to a trail that will satisfy his information need. A probability that a user will be able to notice that a particular page is likely to belong to a trail that will satisfy his information need is called, herein, the “noticeability” of the particular page (and of the particular node in V to which the particular page corresponds). In one embodiment, a particular page's noticeability is determined based on the frequency with which users previously clicked on or otherwise selected a link to the particular page on occasions when a link to the particular page was presented to those users. For example, in one embodiment of the invention, if a link to the particular page was previously presented to various users 1000 times, and if the users clicked on that link 750 times, then the particular page's noticeability would be 0.75 (or 75%).

Each node u in V has an associated noticeability value a(u) which is between 0 and 1 (or between 0% and 100%). Noticeability value a(u) is the probability that a user would identify node u as belonging to a trail (from r) that would satisfy the user's information need if a quicklink to u were presented to the user along with a search result for r. In one embodiment of the invention, a(u) varies from user to user, and is known or approximated for each user specifically based on information known about that user, but in an alternative embodiment of the invention, a(u) is generalized for all users, and does not vary between users. In one embodiment of the invention, the browsing behavior of a multitude of many users relative to website W is monitored and recorded by a search engine (e.g., via a toolbar that executes in conjunction with those users' web browsers and that returns navigation data to the search engine). Thus, the search engine may have access to information that indicates both (a) the amount of time that each user spent browsing a particular web page, and (b) the next web page to which each user navigated after browsing the particular web page. Using averages obtained from this information, browsing behavior relative to website W may be generalized for a plurality of users.

If u is shown as a quicklink along with a search result for r, then, with probability a(u), u will benefit all the trails that pass through u, in that, for all such trails, a user whose information need would be satisfied by any node following u in those trails can access that node with fewer page and link traversals than if that user had to navigate to that node from r instead. The exact amount of benefit depends on the position of u in a trail. Generally, the farther away from r a node U is (in link traversals) in the web graph, the greater the potential benefit is when u is shown as a quicklink under r, because a user then will not need to traverse the one or more links between r and u in order to reach the trail's one or more nodes that satisfy the user's information need. If u is not recognized by the user of the trail (which happens with probability 1−a(u)), then any benefits come from the remaining quicklinks.

### Benefit Function

For each trail p in website W, there is a corresponding benefit function B′ₚ(u) that returns, as its result, the benefit that would be obtained by displaying u as a quicklink, with respect to trail p, assuming that u is noticed by the user. As used herein, “benefit” can include concepts such as the total expected time that would be required for a user to navigate to u from r, and/or the total number of clicks (or hyperlink traversals) that a user would need to make in order to navigate to u from r. For a particular trail p, if u is not on trail p, then B′ₚ(u)=0, since nodes that are not on trail p do not contribute any benefit to a navigator of trail p. For any pair of nodes u and v that are both on a trail p, B′ₚ(u)≧B′ₚ(v) if and only if v is closer to r than u is, since nodes that are farther away (in hyperlink traversals) from root node r on a particular trail benefit a navigator of that trail more than nodes that are closer to root node r on that trail do.

In one embodiment of the invention, the benefit that a particular node provides relative to a trail is based at least in part on the amount of browsing time that users spend on pages on the trail preceding the particular node (the greater the amount of time, the greater the benefit that the particular node provides relative to the trail). As is discussed above, such information may be obtained by a search engine through a browser-accompanying toolbar that returns actual user browsing behavior statistics to the search engine.

As is discussed above, for any trail p, a set of nodes Q|ₚ may be defined to contain only those nodes that occur on trail p. Additionally, for any trail p, a particular node qₗ may be defined as the last node on trail p (i.e., the destination node on trail p, where, in contrast, root node r is the first or origin node on trail p). Because the benefit that a particular node provides relative to a trail becomes greater the farther away from root node r that node lies on the trail (in terms of link traversals required to reach the particular node from root node r), B′ₚ(Q|ₚ)≦B′ₚ(qₗ). The effective benefit that a set of nodes Q|ₚ confers is defined as:

B′ₚ(Q|ₚ)=a(qₗ)·B′ₚ(qₗ)+(1−a(qₗ))·B′ₚ(Q|ₚ\{qₗ}).

In order to attempt to find the “best” k nodes (i.e., the set of k nodes that will provide the greatest benefit as described above) for which quicklinks should be presented in conjunction with root node r, one should seek to find a set of nodes Q (where the cardinality of Q is equal to k) that will maximize the summation of the benefits relative to all trails p in trail superset P (understanding that some trails p in P might not be benefited at all from any node in Q due to none of the nodes in Q being on those trails):

$$B ( P , Q ) = {\sum }_{p ∈ P} {B}_{p} ( Q ) .$$

Techniques for solving this optimization problem (i.e., finding or approximating the set Q that maximizes the above summation) are discussed below.

### Greedy Technique

One technique for approximating a solution to above optimization problem involves a “greedy” approach. In that technique, the set Q of nodes to be selected for display as quicklinks begins as the empty set, and nodes from V are iteratively added to set Q until the cardinality of Q equals k. During each iteration of the technique, the node that will most increase the summation of benefits, given the current composition of set Q, is added to the current set Q. Because the addition of a selected node to set Q changes the benefit of remaining candidate nodes when they occur in trails following the currently selected node,, the value of the increase that would be provided by each of the remaining candidate nodes may change in each iteration.

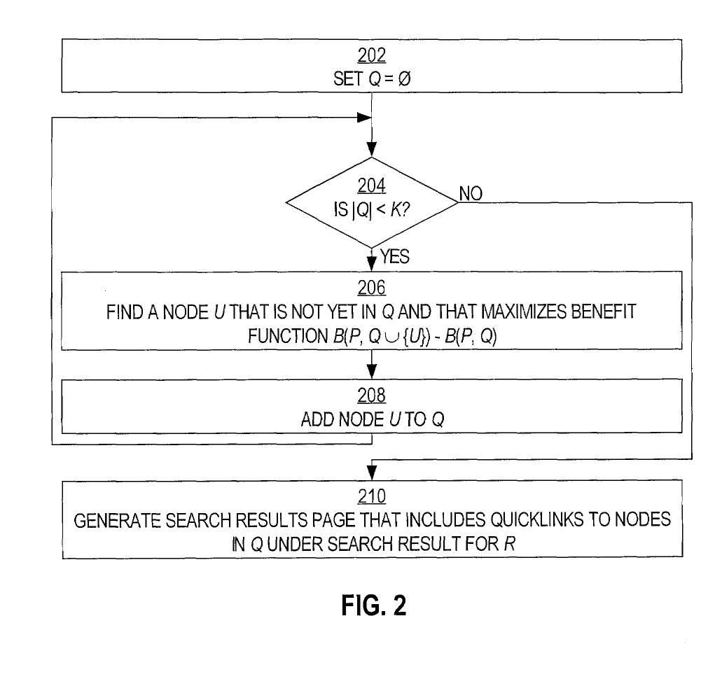

FIG. 2 is a flow diagram that illustrates an example of a “greedy” technique for selecting a set of nodes whose corresponding quicklinks will be displayed in connection with a particular search result on a search results page returned by a search engine, according to one embodiment of the invention. In block 202, an automated mechanism (e.g., a general-purpose computer executing a program, or a machine specifically designed and created to perform only the technique of FIG. 2), sets Q equal to the empty set. In block 204, the automated mechanism determines whether the number of elements in Q (i.e., the cardinality of Q) is less than k. If the cardinality of Q is less than k, then control passes to block 206. Alternatively, if the cardinality of Q is not less than k, then control passes to block 210.

In block 206, the automated mechanism finds a node u that (1) is in V but not yet in Q and also (2) maximizes B(P, Q ∪ {u})−B(P, Q). In other words, the automated mechanism finds, among the not-yet-selected nodes, the node that will most increase the result of the summation discussed above. In order to find node u, the automated mechanism may compute, for each not-yet-selected node, what the current result of the summation would be if that node were added to set Q, and then choose as node u the node that would most increase the result. In block 208, the automated mechanism adds node u to the set of selected nodes Q. Control then passes back to block 204.

Alternatively, in block 210, the automated mechanism generates at least a portion of a search results web page that includes, as a main link for one of the search results, a hypertext link to the root node r of website W, and, beneath and in association with the main link, hypertext quicklinks to each node in set Q. Each such quicklink may display, as anchor text, the title of the web page to which that quicklink points. After generating a complete search results page, the automated mechanism (which may be a component of an Internet search engine) may send the search results web page over the Internet for display by a web browser of a user who originally supplied query terms that caused the search results to be generated. The user may click on or otherwise select a quicklink in order to navigate more quickly to a portion of a website that the user believes will satisfy his information need.

### Tree-Based Technique

Users typically do not want to see a quicklink to a web page if a quicklink to the immediate child of that web page (to which the former web page directly links) is also displayed. Conversely, users typically do not want to see a quicklink to a web page if a quicklink to the immediate parent of that web page (that contains a direct link to the former web page) is also displayed. When a set of presented quicklinks includes quicklinks to parent-child web page pairs, users can become confused. The greedy technique described above does not necessarily prevent such combinations of quicklinks from being selected for presentation.

Additionally, users sometimes find it peculiar if a set of presented quicklinks predominantly contains quicklinks to pages that are very close to the root node, but then a severe minority of other quicklinks that are very distant from the root node, or vice-versa. Users typically are more satisfied with a set of presented quicklinks if the set contains only quicklinks to nodes that are approximately the same distance from the root node, or, in other words, to nodes that are at approximately the same hierarchical level in a tree representation of the website's web graph. The greedy technique described above does not necessarily produce such a hierarchically cohesive set of quicklinks for presentation.

When a website's web graph can be represented as a tree structure, with the root node at the “tip” or “top” of the tree and other nodes as descendants of the root node, then specified constraints can be enforced relative to the selection of quicklinks for that website. For example, the constraints may state that parent-child node pairs may not be contained in the same set of quicklinks for the website, and/or that all quicklinks in the set of quicklinks for the website must be within a specified distance range (in numbers of edges) from the root node if any of those quicklinks is within that distance range.

However, when the set of all trails P of a website are considered together (e.g., by superimposing them upon each other), the result often will not resemble a tree structure; some of the trails will contain a link from a lower-level node (a node that is further from the root node) back to some higher-level node (a node that is closer to the root node). In order to apply the tree-based technique discussed herein, in one embodiment of the invention, certain trails are removed from the website's set of trails P before the technique proceeds further. In one embodiment of the invention, any trail that contains a cycle is removed from the set of trails P. In one embodiment of the invention, only the minimum number of trails needed to cause the remaining trails to conform to a tree structure is removed from P. In one embodiment of the invention, trails that have been navigated by few users (as evidenced by user browsing behavior data collected by the search engine) are preferred for removal from P before the removal of trails that have been navigated by many users; thus, in one embodiment of the invention, the least navigated trails are removed from P first.

In one embodiment of the invention, a separate value v(p) is assigned to each trail p that remains in P. For a particular trail p, the value v(p) is determined by dividing the length of trail p (in number of edges or nodes) by the number of other trails that intersect with trail p (by having at least one node in common with trail p). The set of selected trails that will constitute the resulting tree structure begins as the empty set. All of the trails are ordered by their v(p) values, from highest to lowest. Starting at the trail at the top of the list, that trail is added to the set of selected trails if and only if the addition of that trail will not cause the set of selected trails to cease to represent a tree structure (i.e., if the addition of the trail to the set of selected trails would cause a cycle to be created when the selected trails are superimposed on each other, then the trail is not added to the set of selected trails). After the addition of a trail to the set of selected trails, that trail is removed from the v(p)-ordered list, and all of the remaining trails in the list are re-valued and re-ordered in view of the absence of the added trail (the values may change due to fewer trail intersections for some trails after the removal of a trail from the list). The same operation is performed for the next trail in the v(p)-ordered list, and so on and so forth, until all of the trails in P have been considered for addition to the set of selected trails that represents a tree structure.

According to one embodiment of the invention, the tree structure is converted into a binary tree. This may be done by replacing (1) any internal node u of degree d>2 and with children u₁, . . . u_{d} by (2) a binary tree of depth 1g d and with leaves u₁, . . . u_{d}. Internal nodes of the binary tree will have a noticeability score of zero and therefore will not be selected as quicklinks.

According to one embodiment of the invention, after a tree structure has been generated from the trails as discussed above, a tree-based quicklink selection technique can be performed relative to the tree structure. Constraints of an administrator's choice, such as that parent-child nodes cannot co-exist in the set of selected quicklinks, or that all selected quicklinks must be within a specified range of hierarchical levels within the tree structure (and/or a specified distance away from the root node and/or within a specified distance of each other), may be imposed upon the quicklink selection technique. For example, after the quicklink selection technique has preliminarily selected a set of nodes for inclusion in the set of quicklinks, a computing mechanism can perform one or more tests on the selected nodes to determine whether the selected nodes satisfy various specified constraints. If the mechanism determines that the nodes do not satisfy at least one of the specified constraints, then the mechanism instead selects another, different set of nodes (e.g., the set that next most nearly maximizes the function discussed below) according to the tree-based quicklink selection technique.

In one embodiment of the invention, a set of nodes Q is selected using a selection technique that maximizes the following function, before constraint testing is subsequently performed on the nodes selected as a result:

$$C ( u , Q , k ) = max \{ \begin{matrix}B ( {P}_{u} , Q ) + {max}_{l = 1}^{k} ( C ( {u}_{1} , Q , l ) + C ( {u}_{2} , Q , k - 1 ) ) \\ B ( {P}_{u} , Q ⋃ \{ u \} ) + {max}_{l = 1}^{k - 1} ( \begin{matrix}C ( {u}_{1} , Q ⋃ \{ u \} , l ) + \\ C ( {u}_{2} , Q ⋃ \{ u \} , k - l - 1 )\end{matrix} ) .\end{matrix}$$

In the foregoing equation, Pᵤ is the set of all trails that end at a node u. C(u, Q, k) returns the best effective benefit when Q is the current set of quicklinks (containing the nodes that have already been selected) and when there can be at most k quicklinks in a subtree that is rooted a node u. In the foregoing equation, u1 and u2 are the children of u in the binary tree structure. The base cases are given by C(u, Q, 0)=B(Pᵤ, Q) and by C(u, Q, k)=B(Pᵤ, Q ∪ {u}) for k≧1. The tree-based quicklink selection technique begins by invoking the function with parameters C(r, Ø, k), where r is the root node of the tree structure. The resulting set Q that maximizes the above function contains all of the nodes for which quicklinks are to be displayed under u in the search results page. Thus, according to one embodiment of the invention, the tree-based selection technique selects a set of quicklinks Q with a consideration for all of the quicklinks that are going to be included in Q before placing any single node in Q.

The tree-based approach differs from the greedy approach in that the tree-based approach considers all possible combinations of k quicklinks that could be chosen before choosing the “best” (or most function-maximizing) set of k quicklinks as a whole set. In contrast, the greedy approach selects quicklinks one-at-a-time, without considering whether the whole set actually is the best set.

The above quicklink selection techniques may be performed by a general or special-purpose (designed specifically for the task) computing mechanism periodically, after updated information regarding user browsing behavior has been observed and recorded, or in response to the receipt of query terms by an Internet search engine.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

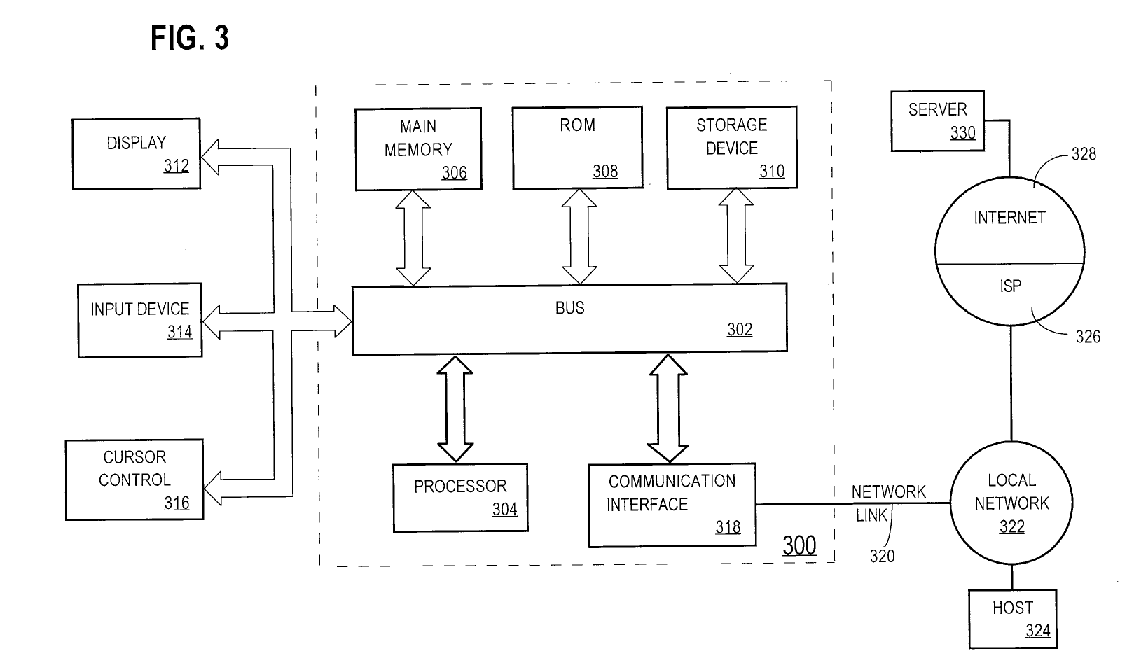

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 310. Volatile media includes dynamic memory, such as main memory 306. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method comprising:
automatically selecting, from a set of nodes, one or more quicklink nodes that will maximize a result of an arithmetic combination;
wherein each node in the set of nodes corresponds to a separate web page of a web site;
wherein the arithmetic combination is an arithmetic combination of results of a benefit function that measures, for each particular trail of a plurality of trails of a website, an effect that a presentation of a specified set of nodes as a set of quicklinks would have relative to the particular trail;
wherein each particular trail of the plurality of trails comprises two or more nodes that are from the set of nodes and through which a traversal may be made by following links between nodes in the particular trail;
wherein the benefit function measures a savings in browsing effort that would be obtained by a user if the user could navigate directly to a particular node rather than navigating a trail from a root node of the website to the particular node;
generating a search results page that contains, in association with a search result that corresponds to the root node, one or more hyperlinks that refer to web pages that correspond to the one or more quicklink nodes; and
presenting the search results page.

2. The method of claim 1, wherein the benefit function measures a number of hypertext links that the user would not need to navigate between the root node and the particular node if the user could navigate directly to the particular node's web page from the search results page.

3. The method of claim 1, wherein the benefit function measures an amount of time that one or more users spent browsing all web pages that lie on a trail between the root node and the particular node.

4. The method of claim 1, wherein selecting the one or more quicklink nodes comprises:
setting a set of currently selected quicklink nodes to be the empty set;
finding, among nodes of the website that have not yet been added to the set of currently selected quicklink nodes, a first node that increases the result of the arithmetic combination more greatly than would any other node of the website that has not yet been added to the set of currently selected quicklink nodes; and
adding the first node to the set of currently selected quicklink nodes.

5. The method of claim 1, wherein selecting the one or more quicklink nodes comprises:
setting a set of currently selected quicklink nodes to be the empty set;
finding, among nodes of the website that have not yet been added to the set of currently selected quicklink nodes, a first node that increases the result of the arithmetic combination more greatly than would any other node of the website that has not yet been added to the set of currently selected quicklink nodes;
adding the first node to the set of currently selected quicklink nodes;
after adding the first node to the set of currently selected quicklink nodes, finding, among nodes of the website that have not yet been added to the set of currently selected quicklink nodes, a second node that increases the result of the arithmetic combination more greatly than would any other node of the website that has not yet been added to the set of currently selected quicklink nodes; and
adding the second node to the set of currently selected quicklink nodes.

6. The method of claim 1, wherein selecting the one or more quicklink nodes comprises:
setting a set of currently selected quicklink nodes to be the empty set;
finding, among nodes of the website that have not yet been added to the set of currently selected quicklink nodes, a first node that increases the result of the arithmetic combination more greatly than would any other node of the website that has not yet been added to the set of currently selected quicklink nodes; and
adding the first node to the set of currently selected quicklink nodes;
wherein an extent to which the first node increases the result of the arithmetic combination depends at least in part on a probability that the user will recognize a hyperlink to the first node's web page as being a hyperlink to a web page that is likely to satisfy an informational need of the user.

7. The method of claim 1, wherein selecting the one or more quicklink nodes comprises:
setting a set of currently selected quicklink nodes to be the empty set;
finding, among nodes of the website that have not yet been added to the set of currently selected quicklink nodes, a first node that increases the result of the arithmetic combination more greatly than would any other node of the website that has not yet been added to the set of currently selected quicklink nodes; and
adding the first node to the set of currently selected quicklink nodes;
wherein an extent to which the first node increases the result of the arithmetic combination depends at least in part on a distance of the first node from the root node measured in link traversals between web pages.

8. The method of claim 1, further comprising:
for each particular trail in the set of trails, assigning to the particular trail a score value that is based at least in part on both (a) a length of the particular trail and (b) a number of other trails in the set of trails that intersect the particular trail;
ranking trails in the set of trails by the score values assigned to the trails, thereby producing a ranked list of trails; and
proceeding down the ranked list of trails in descending order, adding, to a tree structure, each trail from the ranked list whose addition to the tree structure does not cause the tree structure to contain a cycle.

9. A computer-implemented method comprising:
automatically selecting, from a set of nodes, two or more quicklink nodes that will maximize a function;
wherein each node in the set of nodes corresponds to a separate web page of a web site;
wherein a result of the function is based on a measurement, for each particular trail of a plurality of trails of a website, an effect that a presentation of a specified set of nodes as a set of quicklinks would have relative to the particular trail;
wherein each particular trail of the plurality of trails comprises two or more nodes that are from the set of nodes and through which a traversal may be made by following links between nodes in the particular trail;
wherein the function measures a savings in browsing effort that would be obtained by a user if the user could navigate directly to a particular node rather than navigating a trail from a root node of the website to the particular node;
wherein the function maximizes a benefit produced by all of the two or more quicklink nodes considered together; and
generating a search results page that contains, in association with a search result that corresponds to the root node, one or more hyperlinks that refer to web pages that correspond to the one or more quicklink nodes; and
presenting the search results page.

10. The method of claim 9, wherein the step of automatically selecting the two or more quicklink nodes comprises:
determining whether the two or more quicklink nodes selected satisfies one or more specified constraints; and
in response to determining that the two or more quicklink nodes selected do not satisfy at least one of the one or more specified constraints, selecting a different group of quicklink nodes for presentation.

11. A volatile or non-volatile computer-readable storage medium storing one or more instructions which, when executed by one or more processors, cause the one or more processors to perform steps comprising:
automatically selecting, from a set of nodes, one or more quicklink nodes that will maximize a result of an arithmetic combination;
wherein each node in the set of nodes corresponds to a separate web page of a web site;
wherein the arithmetic combination is an arithmetic combination of results of a benefit function that measures, for each particular trail of a plurality of trails of a website, an effect that a presentation of a specified set of nodes as a set of quicklinks would have relative to the particular trail;
wherein each particular trail of the plurality of trails comprises two or more nodes that are from the set of nodes and through which a traversal may be made by following links between nodes in the particular trail;
wherein the benefit function measures a savings in browsing effort that would be obtained by a user if the user could navigate directly to a particular node rather than navigating a trail from a root node of the website to the particular node;
generating a search results page that contains, in association with a search result that corresponds to the root node, one or more hyperlinks that refer to web pages that correspond to the one or more quicklink nodes; and
presenting the search results page.

12. The computer-readable storage medium of claim 11, wherein the benefit function measures a number of hypertext links that the user would not need to navigate between the root node and the particular node if the user could navigate directly to the particular node's web page from the search results page.

13. The computer-readable storage medium of claim 11, wherein the benefit function measures an amount of time that one or more users spent browsing all web pages that lie on a trail between the root node and the particular node.

14. The computer-readable storage medium of claim 11, wherein selecting the one or more quicklink nodes comprises:
setting a set of currently selected quicklink nodes to be the empty set;
finding, among nodes of the website that have not yet been added to the set of currently selected quicklink nodes, a first node that increases the result of the arithmetic combination more greatly than would any other node of the website that has not yet been added to the set of currently selected quicklink nodes; and
adding the first node to the set of currently selected quicklink nodes.

15. The computer-readable storage medium of claim 11, wherein selecting the one or more quicklink nodes comprises:
setting a set of currently selected quicklink nodes to be the empty set;
finding, among nodes of the website that have not yet been added to the set of currently selected quicklink nodes, a first node that increases the result of the arithmetic combination more greatly than would any other node of the website that has not yet been added to the set of currently selected quicklink nodes;
adding the first node to the set of currently selected quicklink nodes;
after adding the first node to the set of currently selected quicklink nodes, finding, among nodes of the website that have not yet been added to the set of currently selected quicklink nodes, a second node that increases the result of the arithmetic combination more greatly than would any other node of the website that has not yet been added to the set of currently selected quicklink nodes; and
adding the second node to the set of currently selected quicklink nodes.

16. The computer-readable storage medium of claim 11, wherein selecting the one or more quicklink nodes comprises:
setting a set of currently selected quicklink nodes to be the empty set;
finding, among nodes of the website that have not yet been added to the set of currently selected quicklink nodes, a first node that increases the result of the arithmetic combination more greatly than would any other node of the website that has not yet been added to the set of currently selected quicklink nodes; and
adding the first node to the set of currently selected quicklink nodes;
wherein an extent to which the first node increases the result of the arithmetic combination depends at least in part on a probability that the user will recognize a hyperlink to the first node's web page as being a hyperlink to a web page that is likely to satisfy an informational need of the user.

17. The computer-readable storage medium of claim 11, wherein selecting the one or more quicklink nodes comprises:
setting a set of currently selected quicklink nodes to be the empty set;
finding, among nodes of the website that have not yet been added to the set of currently selected quicklink nodes, a first node that increases the result of the arithmetic combination more greatly than would any other node of the website that has not yet been added to the set of currently selected quicklink nodes; and
adding the first node to the set of currently selected quicklink nodes;
wherein an extent to which the first node increases the result of the arithmetic combination depends at least in part on a distance of the first node from the root node measured in link traversals between web pages.

18. The computer-readable storage medium of claim 11, wherein the steps further comprise:
for each particular trail in the set of trails, assigning to the particular trail a score value that is based at least in part on both (a) a length of the particular trail and (b) a number of other trails in the set of trails that intersect the particular trail;
ranking trails in the set of trails by the score values assigned to the trails, thereby producing a ranked list of trails; and
proceeding down the ranked list of trails in descending order, adding, to a tree structure, each trail from the ranked list whose addition to the tree structure does not cause the tree structure to contain a cycle.

19. A computer-implemented computer-readable storage medium comprising:
automatically selecting, from a set of nodes, two or more quicklink nodes that will maximize a function;
wherein each node in the set of nodes corresponds to a separate web page of a web site;
wherein a result of the function is based on a measurement, for each particular trail of a plurality of trails of a website, an effect that a presentation of a specified set of nodes as a set of quicklinks would have relative to the particular trail;
wherein each particular trail of the plurality of trails comprises two or more nodes that are from the set of nodes and through which a traversal may be made by following links between nodes in the particular trail;
wherein the function measures a savings in browsing effort that would be obtained by a user if the user could navigate directly to a particular node rather than navigating a trail from a root node of the website to the particular node;
wherein the function maximizes a benefit produced by all of the two or more quicklink nodes considered together; and
generating a search results page that contains, in association with a search result that corresponds to the root node, one or more hyperlinks that refer to web pages that correspond to the one or more quicklink nodes; and
presenting the search results page.

20. The computer-readable storage medium of claim 19, wherein the step of automatically selecting the two or more quicklink nodes comprises:
determining whether the two or more quicklink nodes selected satisfies one or more specified constraints; and
in response to determining that the two or more quicklink nodes selected do not satisfy at least one of the one or more specified constraints, selecting a different group of quicklink nodes for presentation.
